(19) United States
(12) Patent Application Publication
(10) Pub. No.: US 2019/0089183 A9
(43) Pub. Date: Mar. 21, 2019

(54) TRANSMITTER AND RECEIVER COMMUNICATION FOR INDUCTIVE POWER TRANSFER SYSTEMS

(71) Applicant: Apple Inc., Cupertino, CA (US)

(72) Inventors: Jeffrey M. Alves, Cupertino, CA (US); Jeffrey J. Terlizzi, Cupertino, CA (US); Todd K. Moyer, Cupertino, CA (US); Steven G. Herbst, Cupertino, CA (US); David W. Ritter, Cupertino, CA (US); Chad Bossetti, Cupertino, CA (US); Terry Tikalsky, Cupertino, CA (US)

(21) Appl. No.: 14/503,366

(22) Filed: Sep. 30, 2014

Related U.S. Application Data
(60) Provisional application No. 61/894,868, filed on Oct. 23, 2013.

(51) Int. Cl. H02J 7/02; H02J 5/00; H01F 38/14

(52) U.S. Cl. CPC H02J 7/025; H01F 38/14; H02J 5/005

(57) ABSTRACT

Methods and apparatuses for communicating across an inductive charging interface. Methods and apparatuses for improved efficiency of power transfer across an inductive charging interface.

### CROSS-REFERENCE TO RELATED APPLICATION

This application claims the benefit under 35 U.S.C. §119(e) of U.S. Provisional Patent Application 61/894,868, filed on Oct. 23, 2013, entitled “Method and Apparatus for Improved Inductive Power Transfer,” the entirety of which is incorporated herein by reference as if fully disclosed herein.

### TECHNICAL FIELD

This disclosure relates to electromagnetic inductive power transfer, and in particular to adaptive power control systems for maximizing the efficiency of inductive power transfer.

### BACKGROUND

Many electronic devices include one or more rechargeable batteries that require external power to recharge from time to time. These devices may include cell phones, smart phones, tablet computers, laptop computers, wearable devices, navigation devices, sports devices, health devices, accessory devices, and so on.

Often, these devices are charged by tethering to an external power source (e.g., outlet). The tethering connection may be a cable having a connector with electrically conductive contacts that can mate with respective electrically conductive contacts of the electronic device. In some examples, electronic devices may use the received power to replenish the charge of an internal battery.

In some cases, the tethering connection may be exclusively used for power transfer or, in other cases, the connection may be used to transfer power alongside data. Examples of such connectors may include universal serial bus (“USB”), FireWire, peripheral component interconnect express (“PCIe”), or other similar data ports.

In many examples, a user may enjoy and regularly operate multiple electronic devices having internal batteries. These multiple devices often require separate tethering connections having different power outputs and different connector types. Multiple tethering connections are burdensome to use, store, and transport from place to place. As a result, the benefits of device portability may be substantially limited.

Furthermore, charging cords may be unsafe to use in certain circumstances. For example, a driver of a vehicle may become distracted attempting to plug an electronic device into a vehicle charger. In another example, a charging cord may present a tripping hazard if left unattended.

To account for these and other shortcomings of portable electronic devices requiring tethered connections, some electronic devices may include an inductive recharging system. A user may simply place a device on an inductive charging surface to replenish the internal battery. An electromagnetic coil within the inductive charging surface may inductively couple to an electromagnetic coil within the portable electronic device. In this manner, by periodically toggling or alternating the current within the transmit coil, current may be induced in the receive coil. This received current may be used to charge the internal battery of the portable electronic device.

However, due to extra circuitry within the portable electronic device required to support the inductive charging system, battery life of the device may be undesirably reduced. For example, to maintain or reduce the form factor of the device, the battery may be reduced in size or capacity. In another example, the inductive charging system may present a load to the battery when the system is not in use, reducing battery life. Accordingly, although inductively charged devices may be more convenient for the user, the devices may need to be recharged more often.

In other examples, the inductive charging system may inefficiently continue to toggle or alternate the current within the transmit coil long after the electronic device, and thus the receive coil, is no longer present.

Accordingly, there may be a present need for improved methods or apparatuses for delivering useful power to a portable device that does not require a separate power supply and does not itself deplete the battery of the portable electronic device.

### SUMMARY

Embodiments described herein may relate to or take the form of methods and apparatuses for communication across an inductive charging interface. Other embodiments described herein may relate to or take the form of methods and apparatuses for improved efficiency of power transfer across an inductive charging interface.

Certain embodiments may relate to an adaptive power control system for an electromagnetic induction power transfer apparatus. The power control system may include a signal receiver, a power supply configured to switch between an active state and an inactive state at a selectable duty cycle, and a power-transmitting inductor coupled to the power supply. In many cases, the duty cycle of the power supply may be modified in response to a signal received from the signal receiver.

Other embodiments may include a configuration in which the power supply may be set to the inactive state in the absence of a signal received from the signal receiver. Further embodiments may include a configuration in which the signal may be received when the power supply may be in the inactive state. Still other embodiments may include a configuration in which the signal received from the signal receiver may be a signal sent from a portable electronic device having a power-receiving inductor and being positioned inductively proximate the power-transmitting inductor.

Other embodiments may include a configuration in which the signal comprises an instruction to increase, decrease, or otherwise change the selectable duty cycle of the power supply. These and related embodiments may include a configuration in which the signal receiver may be coupled to the power-transmitting inductor and configured to sense changes in inductive load to the power-transmitting inductor.

Other embodiments may include a configuration in which the signal receiver may be coupled to the power-transmitting inductor and configured to sense changes in voltage or current across the power-transmitting inductor. Other embodiments may include a configuration in which the signal receiver may be coupled to the power-transmitting inductor and comprises a carrier frequency detector. These and related embodiments may include a configuration in which the power supply defines the active state to correspond to a select power output level.

Other embodiments may include a configuration in which in response to a signal received from the signal receiver the power supply increases the select power output level of the active state. In such an embodiment, the power supply may decrease, increase, or otherwise change the selectable duty cycle in proportion to the increase in the select power output. For example, if the voltage may be requested to increase two-fold, the duty cycle may decrease by half.

Other embodiments may include a configuration in which the power supply selects the selectable duty cycle to be at or near a resonance frequency of a system defined by the power-transmitting inductor and the power-receiving inductor. Related examples may include a configuration in which the power supply selects the period of the active state of the selectable duty cycle to be at or near a resonance frequency of a system defined by the power-transmitting inductor and the power-receiving inductor.

Other embodiments may include a configuration in which the power-transmitting inductor comprises an electromagnetic coil formed with an electrically conductive wire with an axially asymmetric cross section, such as a rectangle or a square. Certain further embodiments may include a configuration in which the power-transmitting inductor comprises a plurality of electromagnetic coils.

Other embodiments may include a configuration in which the power-transmitting inductor comprises an electromagnetic coil having a select number of turns and a core wherein the core at least partially abuts at least one edge of each turn of the select number of turns. In still further embodiments, the core may at least partially abut at least one edge of a select number of turns.

Certain further embodiments described herein may relate to or take the form of an adaptive power system including a configuration having a power transmitter and a power receiver. The power transmitter, in certain configurations may include a signal receiver configured to receive an instruction, a power supply configured to switch between an active state and an inactive state at a selectable duty cycle, and a power-transmitting inductor coupled to the power supply. The power receiver may include in certain configurations a battery, a power-receiving inductor having at least an active state and an inactive state, and a signal transmitter coupled to the power-receiving inductor configured to send an instruction.

Other related embodiments may include a condition or configuration in which the signal transmitter may be configured to send an instruction to the signal receiver. In some examples, this instruction may be sent during the inactive state of the power supply. Sending the instruction may, for example, include coupling the power-receiving coil to a power source output modulated to follow a selected waveform. The waveform of the power source may vary. For example, the waveform may be a high frequency pulse, or a single direct current pulse.

In order to detect the instruction sent as a result of coupling the power-receiving coil to the selected waveform, the signal receiver may include in certain configurations peak detection circuitry configured to measure a voltage corresponding to the voltage of the single direct current pulse.

As noted with respect to embodiments described above, the instruction may include an indication to increase, decrease, or otherwise change the duty cycle of the power supply. In other examples, the instruction may be an indication to increase, decrease or otherwise change a voltage or current output during the active state of the power supply.

In still further configurations, embodiments described herein may relate to or take the form of an adaptive power system for an electronic device including a power transmitter including an optical sensor, a power supply configured to switch between an active state and an inactive state at a selectable duty cycle, and a power-transmitting inductor coupled to the power supply. A power receiver may include a light source, and a power-receiving inductor having at least an active state and an inactive state. In these and related embodiments, the light source may be configured to send an instruction to the optical sensor.

Related alternate embodiments may include a configuration in which the light source comprises a light emitting diode. The light source may emit infrared or visible light.

These and other related alternate embodiments may include a configuration in which the instruction comprises an indication to enable a communication circuit within the power transmitter. For example, when the light source begins emitting light, the optical sensor may send an indication to power on wireless communication circuitry such as a radio. In other examples, the instruction may be to increase, decrease or otherwise change the duty cycle of the power supply or, in the alternative, increase, decrease, or otherwise change a voltage or current being applied to the power-transmitting inductor.

Still further embodiments described herein may relate to or take the form of a system of wireless communication comprising a signal origination apparatus comprising a first electric dipole portion, a variable voltage source coupled to the first electric dipole portion, a signal termination apparatus comprising, a second electric dipole portion; and a voltage detector coupled to the second electric dipole portion. In such an example, a modification of the variable voltage output from the variable voltage source may be detected by the voltage detector.

### BRIEF DESCRIPTION OF THE FIGURES

Reference will now be made to representative embodiments illustrated in the accompanying figures. It should be understood that the following descriptions are not intended to limit the embodiments to one preferred embodiment. To the contrary, it is intended to cover alternatives, modifications, and equivalents as may be included within the spirit and scope of the described embodiments as defined by the appended claims.

FIG. 1 is a simplified block diagram of a frequency controlled inductive charging system.

FIG. 2 is a simplified process flow diagram of one exemplary method of operating a receiving circuit in an inductive charging system.

FIG. 3 is a simplified process flow diagram of another exemplary method of operating a receiving circuit in an inductive charging system.

FIG. 4 is a simplified process flow diagram of one exemplary method of operating a transmitting circuit in an inductive charging system.

FIG. 5 is a simplified schematic diagram of a receiving circuit in an inductive charging system.

FIG. 6 is a simplified schematic diagram of a wireless communication system employing a pair of electric dipoles.

FIG. 7 is a simplified process flow diagram of another exemplary method of operating a receiving circuit in an inductive charging system.

FIG. 8A is a simplified graphical representation of a sample waveform to drive a power-transmitting coil in an inductive charging system.

FIG. 8B is a simplified graphical representation of a sample waveform to drive a power-transmitting coil in an inductive charging system.

FIG. 9A is a simplified plan view of an electromagnetic coil.

FIG. 9B is a cross section of the electromagnetic coil shown in FIG. 9A taken along line 9-9, showing three turns of five rows of a square conductor.

FIG. 10 is a cross section of the electromagnetic coil shown in FIG. 9A take along line 9-9, showing three turns of five rows of a cylindrical conductor having a core portion interlaying each of the five rows.

The use of the same or similar reference numerals in different drawings indicates similar, related, or identical items.

### DETAILED DESCRIPTION

Embodiments described herein may relate to or take the form of methods and apparatuses for communication across an inductive charging interface. Other embodiments described herein may relate to or take the form of methods and apparatuses for improved efficiency of power transfer across an inductive charging interface. An inductive charging system may include an inductive charging station to transmit power and a portable electronic device to receive power. Portable electronic devices may include media players, media storage devices, personal digital assistants, tablet computers, cellular telephones, laptop computers, smart phones, styluses, global positioning sensor units, remote control devices, wearable devices, electric vehicles, home appliances, medical devices, health devices and the like.

Certain embodiments may take the form of power management systems within a portable electronic device that are configured to communicate to with and couple to an inductive charging station or dock. For example, when a portable electronic device is placed inductively proximate to an inductive charging station, the portable electronic device may activate inductive charging circuitry and may communicate to the inductive charging station that the portable electronic device may be ready to receive power. Such circuitry may include a power-receiving inductor or, in other words, a power receiving coil.

The receive coil included within a portable electronic device may be complimented by a transmit coil included as a portion of an inductive charging station. When the portable electronic device is placed inductively proximate the charging station, a mutual inductance between the transmit coil and the receive coil may be utilized for power transfer.

The quality of the mutual inductance or inductive coupling may be substantially affected by many factors including the relative alignment of the transmit coil and the receive coil and the distance between the two. For example, for increased power transfer between the transmit and the receive coil, the coils are preferably positioned close together and aligned along a mutual axis. By varying applying a time-varying current to the transmit coil, the receive coil may enjoy an induced current useful for charging a battery internal to the portable electronic device.

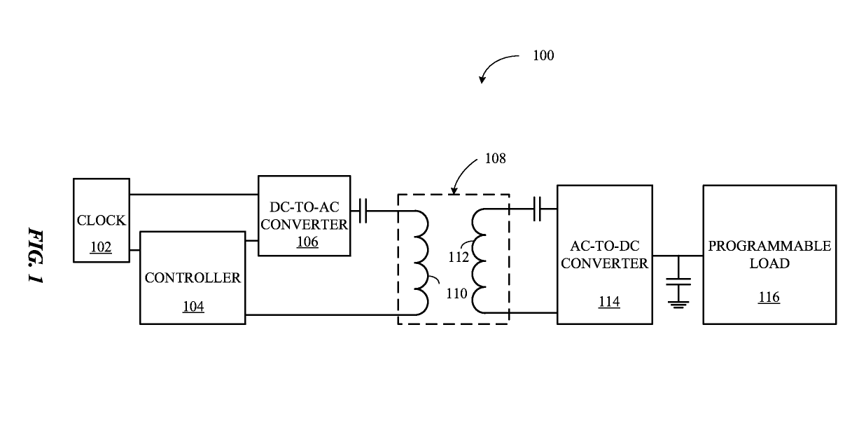

Referring now to FIG. 1, a simplified block diagram of an exemplary frequency controlled inductive charging system is shown. The inductive charging system 100 includes a clock circuit 102 operatively connected to a controller 104 and a direct current converter 106. The clock circuit 102 can generate the timing signals for the inductive charging system 100.

The controller 104 can control the state of the direct current converter 106. In one embodiment, the clock circuit 102 generates periodic signals that are used by the controller 104 to activate and deactivate switches in the direct current converter 106 on a per cycle basis. Any suitable direct current converter 106 can be used in the inductive charging system 100. For example, in one embodiment, an H bridge may be used as a direct current converter. H bridges are known in the art, so only a brief summary of the operation of an H bridge is described herein.

The controller 104 controls the closing and opening of four switches S1, S2, S3, S4 (not illustrated). When switches S1 and S4 are closed for a given period of time and switches S2 and S3 are open, current may flow from a positive terminal to a negative terminal through a load. Similarly, when switches S2 and S3 are closed for another given period of time while switches S1 and S4 are open, current flows from the negative terminal to the positive terminal. This opening and closing of the switches produces a time-varying current by repeatedly reversing the direction of the current through the load same load.

In an alternate embodiment, an H bridge may not be required. For example, a single switch may control the flow of current from the direct current converter 106. In this manner, the direct current converter 106 may function as a square wave generator.

The time-varying signal or square wave signal produced by the direct current converter 106 may be input into a transformer 108. Typically, a transformer such as those used in the above-referenced tethered charging systems includes a primary coil coupled to a secondary coil, with each coil wrapped about a common core. However, an inductive charging system as described herein includes a primary and a secondary coil separated by an air gap and the respective housings containing each coil. Thus, as illustrated, transformer 108 may not necessarily be a physical element but instead may refer to the relationship and interface between two inductively proximate electromagnetic coils such as a primary coil 110 and a secondary coil 112.

The foregoing is a simplified description of the transmitter and its interaction with a secondary coil 112 of an inductive power transfer system. The transmitter may be configured to provide a time-varying voltage to the primary coil 110 in order to induce a voltage within the secondary coil 112. Although both alternating currents and square waves were pointed to as examples, one may appreciate that other waveforms are contemplated. In such a case, the controller 104 may control a plurality of states of the direct current converter 106. For example, the controller 104 may control the voltage, current, duty cycle, waveform, frequency, or any combination thereof.

The controller 104 may periodically modify various characteristics of the waveforms applied to the primary coil 110 in order to increase the efficiency of the operation of the power transmitting circuitry. For example, in certain cases, the controller 104 may discontinue all power to the primary coil 110 if it is determined that the secondary coil 112 may not be inductively proximate the primary coil 110. This determination may be accomplished in any number of suitable ways. For example, the controller 104 may be configured to detect the inductive load on the primary coil 110. If the inductive load falls below a certain selected threshold, the controller 104 may conclude that the secondary coil 112 may not be inductively proximate the primary coil 110. In such a case, the controller 104 may discontinue all power to the primary coil 110.

In other cases, in one embodiment the controller 104 may set the duty cycle to be at or near a resonance frequency of the transformer 108. In another example, the period of the waveform defining the active state of the duty cycle (i.e., high) may be selected to be at or near the resonance frequency of the transformer 108. One may appreciate that such selections may increase the power transfer efficiency between the primary coil 110 and the secondary coil 112.

In an alternate example, the controller 104 may discontinue all power to the primary coil 110 if a spike in inductive load is sensed. For example, if the inductive load spikes at a particular rate above a certain selected threshold the controller 104 may conclude that an intermediate object may be placed inductively proximate the primary coil 110. In such a case, the controller 104 may discontinue all power to the primary coil 110.

In still further examples, the controller 104 may modify other characteristics of the waveforms applied to the primary coil 110. For example, if the receiver circuitry requires additional power, the controller 104 may increase the duty cycle of the waveform applied to the primary coil 110. In a related example, if the receiver circuitry requires less power, the controller 104 may decrease the duty cycle of the waveform applied to the primary coil 110. In each of these examples, the time average power applied to the primary coil 110 may be modified.

In another example, the controller 104 may be configured to modify the magnitude of the waveform applied to the primary coil 110. In such an example, if the receiver circuitry requires additional power, the controller 104 may amplify the maximum voltage of the waveform applied to the primary coil 110. In the related case, the maximum voltage of the waveform may be reduced if the receiver circuitry requires less power.

Turning back to FIG. 1, and as noted above, the transmitter portion of the inductive power transfer system may be configured to provide a time-varying signal to the primary coil 110 in order to induce a voltage within the secondary coil 112 in the receiver through inductive coupling between the primary coil 110 and the secondary coil 112. In this manner, power may be transferred from the primary coil 110 to the secondary coil 112 through the creation of a varying magnetic flux by the time-varying signal in the primary coil 110.

The time-varying signal produced in the secondary coil 112 may be received by an direct current converter 114 that converts the time-varying signal into a DC signal. Any suitable direct current converter 114 can be used in the inductive charging system 100. For example, in one embodiment, a rectifier may be used as an direct current converter. The DC signal may then be received by a programmable load 116.

In some embodiments, the receiver direct current converter 114 may be a half bridge. In such examples, the secondary coil 112 may have an increased number of windings. For example, in some embodiments, the secondary coil may have twice as many windings. In this manner, as one may appreciate, the induced voltage across the secondary coil 112 may be reduced by half, effectively, by the half bridge rectifier. In certain cases, this configuration may require substantially fewer electronic components. For example, a half bridge rectifier may require half as many transistors as a full wave bridge rectifier. As a result of fewer electronic components, resistive losses may be substantially reduced.

In certain other embodiments, the receiver may also include circuitry to tune out magnetizing inductance present within the transmitter. As may be known in the art, magnetizing inductance may result in losses within a transformer formed by imperfectly coupled coils. This magnetizing inductance, among other leakage inductance, may substantially reduce the efficiency of the transmitter. One may further appreciate that because magnetizing inductance may be a function of the coupling between a primary and secondary coil, that it may not necessarily be entirely compensated within the transmitter itself. Accordingly, in certain embodiments discussed herein, tuning circuitry may be included within the receiver. For example, in certain embodiments, a capacitor may be positioned parallel to the programmable load 116.

In still further examples, a combination of the above-referenced sample modifications may be made by the controller. For example, the controller 104 may double the voltage in addition to reducing the duty cycle. In another example, the controller may increase the voltage over time, while decreasing the duty cycle over time. One may appreciate that any number of suitable combinations are contemplated herein.

Other embodiments may include multiple primary coils 110. For example, if two primary coils are present, each may be activated or used independently or simultaneously. In such an embodiment, the individual coils may each be coupled to the controller 104. In further examples, one of the several individual primary coils 110 may be selectively shorted. For example, a switch may be positioned in parallel to the coil such that when the switch is off current may run through the inductor. On the other hand, when the switch is on, no current will run through the coil. The switch may be any suitable type of manual, solid state, or relay based switch. In this manner, the amount of increase in current through each of the several coils may be electively controlled. For example, in a circumstance with a high inductive load, the switch may be turned off to include the coil in the circuit with the primary coil 110.

In the present disclosure, the methods disclosed may be implemented or otherwise embodied by circuitry or other digital or analog logical elements. For example, steps of “sending”, “receiving”, “determining”, “interpreting”, “requesting”, “authorizing” and the like may be understood to refer to the respective inputs and outputs of circuitry configured to perform the functions described. These circuits or logical elements may also have direct or indirect control over the functionality of the receiver or transmitter respectively. Further, it is understood that the specific order or hierarchy of steps in the methods disclosed are examples of sample approaches, and may be in certain circumstances accomplished by multiple independent circuits or logical elements or, in other examples, by a single circuit or logical element. In still further examples, the referenced steps may not necessarily include or require specific decisional or intelligent circuitry. In other words, the embodiments described herein may include any combination of analog circuits, digital circuits, or software. In other embodiments, the specific order or hierarchy of steps in any method or process may be rearranged while remaining within the disclosed subject matter.

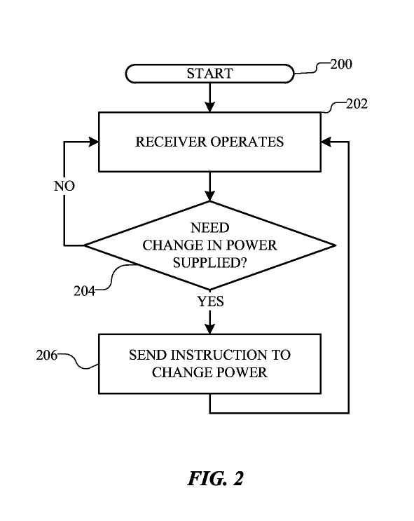

FIG. 2 is a simplified process flow diagram of one exemplary method of operating a receiving circuit in an inductive charging system. The method may begin with the receiver initiating or starting at 200. Thereafter, the receiver may enter an operational loop beginning with step 210. At 220, the receiver may determine that additional power is required of the transmitter circuitry. For example, the receiver may determine that the internal battery may be in need of replenishment. In another example, the receiver may determine that other circuitry within the portable electronic device may be enabled, requiring additional power. In another example, the receiver may determine that less power may be necessary. For example, the receiver may determine that the internal battery is fully charged.

Once the receiver determines that a change in power is required at 220, it may send an instruction to change the amount of power at 230. This instruction may be directed to the transmitter circuitry that is providing the power to the receiver. In certain embodiments, the signal may be sent using a wireless communication element within the electronic device. For example a Bluetooth, Wi-Fi or cellular connection may be used. In other examples, a near-field communication element may be used.

In further embodiments, the instruction may be sent over a signal through the inductive link with the transmitter. As noted with respect to the discussion of the embodiment shown in FIG. 1, the inductive link may refer to the inductive coupling between the primary coil (transmitter) and the secondary coil (receiver).

However for certain embodiments discussed herein relating to duty cycling of the power applied to the primary coil, communication over the inductive link may prove challenging. For example, if the duty cycle of the waveform applied to the primary coil is sufficiently high, there may be little time for a signal to be sent between the receiver and the transmitter in order to adjust the power requirements as needed.

Another issue may arise if the transmitter is placed in a standby state. For example, if the transmitter is not transmitting. There may be no opportunity for the receiver to send a signal over the inductive link because the inductive link does not exist.

To account for this, certain embodiments may provide the communication signal as a very high frequency carrier wave over the waveform applied to the primary coil. In this manner, each of the transmitter and receiver may include a radio transmitter or similar circuitry. In one example, the radio transmitter coupled to the receiver may modulate the load the receiver (secondary) coil presents to the transmitter. In this manner the receiver may communicate with the transmitter as required at 230 by employing load modulation at a frequency substantially higher than the duty cycle of the waveform applied to the primary coil.

In another embodiment, the receiver may send a signal to the transmitter only when the transmitter is in an inactive state. For example, during the inactive state of a duty cycle the receive coil may pulse once or multiple times, and the amplitude may be variable or fixed. The transmit coil may receive the pulses and interpret them to adjust the duty cycle. In one example, the receiver may determine its timing from a pulse across a capacitor in the receiver which resonates during the transmit cycle. This may be used to tune a timer to adjust the ‘reflected’ (i.e. from receiver to transmitter) pulse time and period. In this manner, the receiver and transmitter may form a closed feedback loop which automatically adjusts transmitted power (i.e., duty cycle) based on the requirements of the receiver. The transmitter may use a standard peak sensing circuit to determine the amplitude of the voltage signal sent by the receiver. In this manner, the receive coil may communicate with the transmitter as required at 230.

In an alternate example, a more passive technique may be used. A very high frequency pulse sent from the transmit coil may cause the receive coil to reflect a voltage back within the transmit coil in proportion to the windings ratio. For example, if the transmit coil to receiver coil windings ratio is 1:2 and the receive coil experiences 4V, the transmit coil may receive 2V. By measuring this reflected 2V the transmitter may infer that 4V are present in the receiver, and may begin switching again. One may note that the coupling may also influence the reading at the transmitter. For example, less than 2V may be measured. In such examples, compensation may be necessary. For example, the transmit coil may compare the reflected voltage to an expected reflected voltage. The ratio between these two measurements may be used to compensate for imperfect coupling. In other examples, the transmit coil may measure changes in the reflected voltage as a function of time. In this manner, the transmit coil may determine that the voltage at the receiver has change by a certain amount. In other examples, the transmitter may communicate to the receiver that the inductive link is not properly aligned via an alternate communication link. For example, the transmitter may send a message or instruction over Bluetooth, Wi-Fi, near field communication, or any other suitable alternate communication mechanism. The receiver may receive this instruction and alert the user that alignment of the receiver to the transmitter is insufficient. In other examples, the transmitter may communicate to the receiver by using other embodiments described herein. For example, if the passive reflection technique does not return the expected voltage, the transmitter may impose a carrier over the inductive link to communicate with the receiver. In these and other ways, the receive coil may communicate with the transmitter as required at 230.

In other embodiments, the transmitter may periodically request of the receiver whether it may begin a load switching step. The receiver may grant the request relatively quickly, for example 10-100 μs, after the request is sent. The receiver may communicate a request to increase power over the inductive link via load modulation as described above. In this manner, the receiver and transmitter may enjoy a slave-master relationship such that whenever the receiver needed additional power, the receiver would wait until the next transmit cycle to deliver its request. In this manner, the receive coil may communicate with the transmitter as required at 230.

In certain cases, the request may be for the pulse rate to increase, an increase in the duty cycle, an increase in the voltage of the primary coil, etc. In certain cases, a known load curve may be used to preemptively increase the power output.

In still further examples, the transmit coil may be placed into a receiving mode and the receiving coil may be placed in a transmit mode. The receive coil may be excited to a certain amplitude or rate for the sole purpose of communicating a power requirement or other information to the transmit coil and transmit circuitry. This reversal of modes may be completed periodically, regularly, or on demand. In this manner, the receive coil may communicate with the transmitter as required at 230.

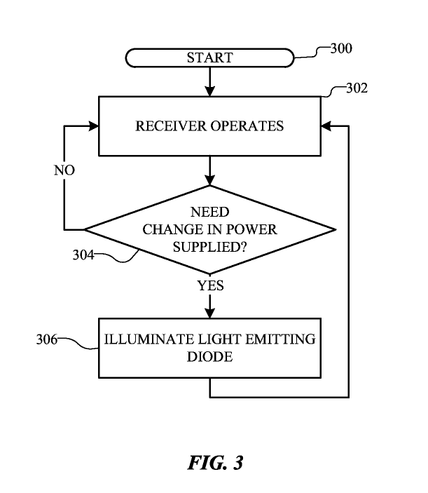

FIG. 3 is a simplified process flow diagram of another exemplary method of operating a receiving circuit in an inductive charging system. The method may begin with the receiver initiating or starting at 300. Thereafter, the receiver may enter an operational loop beginning with step 310. The receiver may determine that additional power is required of the transmitter circuitry at 320. In order to signal a need to increase power, a light source may be illuminated at 330. The light source may be an LED capable to emit either visible or infrared light, or any other suitable spectrum. The LED may be a component that has another purpose in the receiver device. For example, if the receiver device is a portable electronic device including a camera, the LED may be a flash which may be associated with the camera. In another example, if the electronic device is a wearable heath monitor that includes a photoplethysmographic (PPG) sensor to determine relative blood flow, the LED may be an associated infrared illuminator.

The transmitter may include an optical sensor oriented to detect whether the light source is illuminated. In certain cases the optical sensor and/or the LED may include lenses in order to focus and direct light.

In some embodiments, the signal sent by the LED may cause the transmitter to wake in order to begin communication over the inductive link. In other examples, the LED may be illuminated by a pulse width modulated (PWM) signal that may be interpreted by the optical sensor as including data. In still further embodiments, the LED may be illuminated and extinguished in a particular sequence in order to convey data to the transmitter.

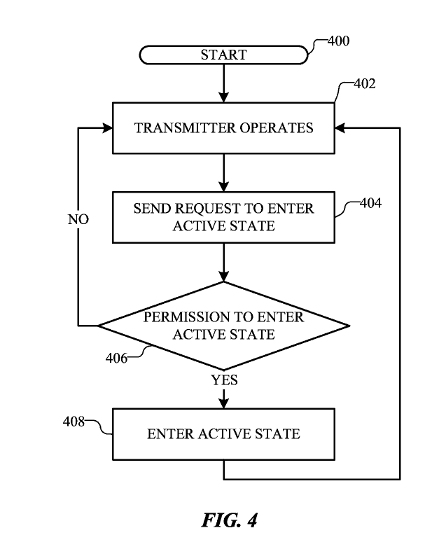

FIG. 4 is a simplified process flow diagram of one exemplary method of operating a transmitting circuit in an inductive charging system. The method may begin with the receiver initiating or starting at 400. Thereafter, the transmitter may enter an operational loop beginning with step 410. At 420, the transmitter may send a request to enter the active state. After the request to enter the active state, the transmitter may determine whether it has received permission to enter the active state at 430. In some examples, permission may be explicit. For example, the transmitter may receive a positive authorization to enter the active state from a receiver. In other examples, permission denial may be implied. For example, the transmitter may not receive any signal from the receiver.

After the transmitter determines that it has permission to enter the active state the transmitter may take steps appropriate to enter the active state at 440.

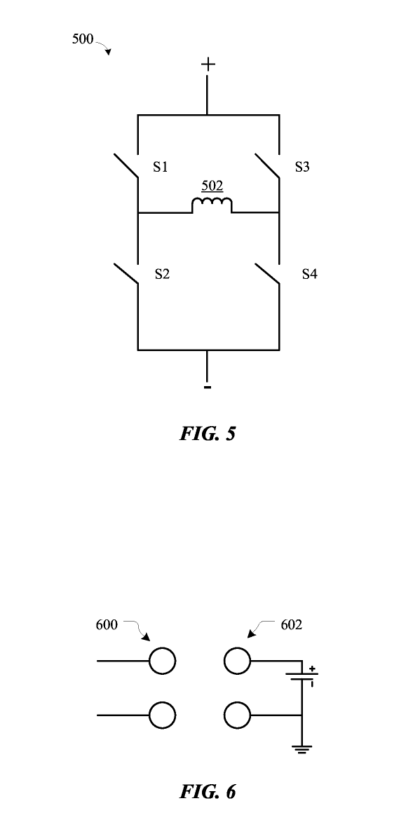

FIG. 5 is a simplified schematic diagram of a receiving circuit in an inductive charging system shown an example H bridge. In this example, as partially described with respect to FIG. 2, the receiver may employ load modulation in order to communicate to the transmitter. In this example, an H bridge may be used to vary a signal output from the secondary coil. Here, the receiver coil (secondary coil) 502 is illustrated in conjunction with four switches S1, S2, S3, and S4. When switches S1 and S4 are closed for a given period of time and switches S2 and S3 are open, current may flow from a positive terminal to a negative terminal through a load. Similarly, when switches S2 and S3 are closed for another given period of time while switches S1 and S4 are open, current flows from the negative terminal to the positive terminal. This opening and closing of the switches produces a time-varying current by repeatedly reversing the direction of the current through the load same load. In this manner the receiver may produce a signal that may be understood and interpreted by the transmitter.

FIG. 6 is a simplified schematic diagram of a wireless communication system employing a pair of electric dipoles. In this illustration two sets of dipoles 600 and 602 are positioned proximate one another. In this manner, voltage variations in 602 may be received and interpreted by 600. One may appreciate that the reverse may also be true. In this manner, the receive coil may communicate with the transmitter, even when the inductive link is not active.

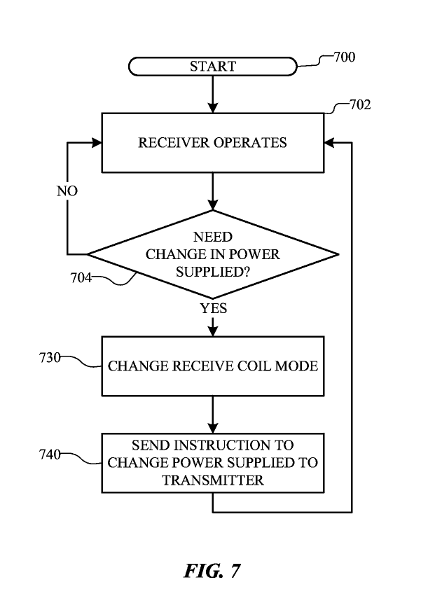

FIG. 7 is a simplified process flow diagram of another exemplary method of operating a receiving circuit in an inductive charging system. The method may begin with the receiver initiating or starting at 700. Thereafter, the receiver may enter an operational loop beginning with step 710. At 720, the receiver may determine that additional power is required of the transmitter circuitry. Thereafter, the receiver may change the mode of the receiver coil to a transmit mode at 730. Once in the transmit mode, the receiver coil may transmit an instruction to the transmitter coil at 740.

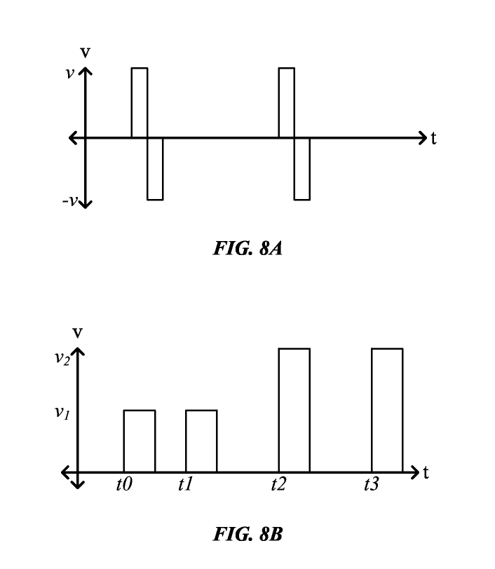

FIG. 8A is a simplified graphical representation of a sample waveform to drive a power-transmitting coil in an inductive charging system. Shown are two example periods of a single square wave pulse from −v to +v. As noted with respect to FIG. 1, the individual periods may be sufficiently timed so as to cause the transformer 108 (see e.g., FIG. 1) to resonate.

FIG. 8B is a simplified graphical representation of a sample waveform to drive a power-transmitting coil in an inductive charging system. Shown are four example active states. A first active state shows a duty cycle defined from time t0 to time t1 with a maximum voltage of v1. A second active state shows a duty cycle defined from time t2 to t3 with a maximum voltage of v2. The first active state may complete in half the amount of time as the second active state. The first active state may also have a half the maximum voltage as the second active state. In this manner, the first active state has half the voltage but operates for twice as long as the second active state. This may be a representative waveform similar to those described with respect to FIG. 1.

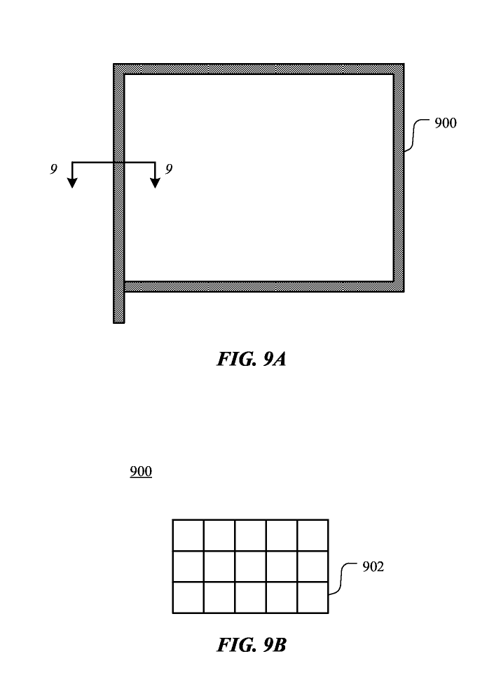

FIG. 9A is a simplified plan view of an electromagnetic coil 900 showing a square shape. One may appreciate that although illustrated as a square, many alternate configurations are considered. FIG. 9B is a cross section of the electromagnetic coil 900 shown in FIG. 9A taken along line 9-9, showing fifteen turns in three columns and five rows of a square conductors 910. Because the square is not axially symmetric in the direction of current flow, the skin effect is reduced in comparison to axially symmetric (circular cross section) wires.

Although three columns and five rows are shown, one may appreciate that other configurations and turn counts are contemplated.

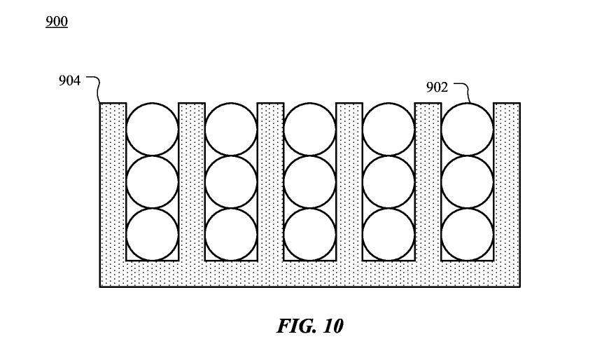

FIG. 10 is a cross section of the electromagnetic coil 900 shown in FIG. 9A taken along line 9-9, showing three turns of five rows of a cylindrical conductor 910 having a core portion interlaying each of the five rows. In this manner the core at least partially abuts at least one edge of each turn of the select number of turn. In certain further embodiments, the core may abut an edge of every other turn or, alternately, may abut an edge of every n number of turns. For example, four turns may be grouped together, with a portion of the core abutting the group.

In certain embodiments, such as the embodiment illustrated in FIG. 10, the core may be constructed with tines or extensions. In other embodiments, the selected number of turns may be entirely or partially painted or coated with a ferrite material that is electrically coupled a core portion.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

1.-49. (canceled)

50. An adaptive power control system for an electromagnetic induction power transfer apparatus comprising:
a signal receiver;
a power supply with an active state and an inactive state, configured to switch between the active state and the inactive state at a selectable duty cycle;
a power-transmitting inductor coupled to the power supply;
wherein:
the duty cycle of the power supply is modified in response to a signal received from the signal receiver.

51. The adaptive power control system of claim 50, wherein the power supply is set to the inactive state in the absence of a signal received from the signal receiver.

52. The adaptive power control system of claim 50, wherein the signal is received when the power supply is in the inactive state.

53. The adaptive power control system of claim 50, wherein the signal received from the signal receiver is a signal sent from a portable electronic device having a power-receiving inductor and positioned inductively proximate the power-transmitting inductor.

54. The adaptive power control system of claim 53, wherein the signal comprises an instruction to increase the selectable duty cycle of the power supply.

55. The adaptive power control system of claim 53, wherein the signal comprises an instruction to decrease the selectable duty cycle of the power supply.

56. The adaptive power control system of claim 50, wherein the signal is received when the power supply in either the active state or the inactive state.

57. The adaptive power control system of claim 50, wherein the signal receiver is coupled to the power-transmitting inductor and configured to sense changes in inductive load to the power-transmitting inductor.

58. The adaptive power control system of claim 50, wherein the signal receiver is coupled to the power-transmitting inductor and configured to sense changes in voltage across the power-transmitting inductor.

59. An adaptive power system comprising:
a power transmitter comprising:
a signal receiver configured to receive an instruction;
a power supply with an active state and an inactive state, configured to switch between the active state and the inactive state at a selectable duty cycle; and
a power-transmitting inductor coupled to the power supply; and
a power receiver comprising:
a battery;
a power-receiving inductor having at least an active state and an inactive state; and
a signal transmitter coupled to the power-receiving inductor configured to send an instruction.

60. The adaptive power system of claim 59, wherein the power supply is set to the inactive state in the absence of an instruction received by the signal receiver.

61. The adaptive power system of claim 60, wherein the signal transmitter is configured to send an instruction to the signal receiver.

62. The adaptive power system of claim 61, wherein the instruction is sent during the inactive state of the power supply.

63. The adaptive power system of claim 61, wherein sending the instruction comprises coupling the power-receiving coil to a power source output, the power source output modulated to follow a selected waveform.

64. The adaptive power system of claim 63, wherein the selected waveform comprises a high frequency pulse, wherein the frequency of the pulse is selected such that at least one period of the pulse may be sent during the inactive state of the power supply.

65. The adaptive power system of claim 62, wherein the instruction comprises an indication to increase the duty cycle of the power supply.

66. The adaptive power system of claim 62, wherein the instruction comprises an indication to decrease the duty cycle of the power supply.

67. The adaptive power system of claim 62, wherein the instruction comprises an indication to increase a voltage output during the active state of the power supply.

68. The adaptive power system of claim 62, wherein the instruction comprises an indication to decrease a voltage output during the active state of the power supply.

69. An adaptive power system comprising:
a power transmitter comprising:
a power supply with an active state and an inactive state, configured to switch between the active state and the inactive state;
a first communication controller configured to request permission to enable the active state; and
a power-transmitting inductor coupled to the power supply; and
a power receiver comprising:
a battery;
a power-receiving inductor having at least an active state and an inactive state; and
a second communication controller coupled to the power-receiving inductor configured to receive the request;
wherein the second communication controller configured to send an indication to the first communication controller to enable the active state upon receipt of the request.
